(19) United States
(12) Patent Application Publication
(10) Pub. No.: US 2019/0278127 A1
(43) Pub. Date: Sep. 12, 2019

(54) PANEL MODULE

(71) Applicant: SHARP KABUSHIKI KAISHA, Sakai City (JP)

(72) Inventor: KAZUYA MURAKAMI, Sakai City (JP)

(21) Appl. No.: 16/289,980

(22) Filed: Mar. 1, 2019

(30) Foreign Application Priority Data
Mar. 6, 2018 (JP) 2018-039490

(51) Int. Cl. G02F 1/1333; G02F 1/1335

(52) U.S. Cl. CPC G02F 1/133308; G02F 1/133528; G02F 1/13338; G06F 3/044; G02F 2001/133311; G02F 2001/133562; G02F 2001/133331

(57) ABSTRACT

A panel module includes: a panel member including a substrate with a plate surface that is extended along a direction intersecting with a horizontal direction, and a conductive member formed on the plate surface; a cover panel that covers the panel member from a side of the plate surface; an attaching member that is used to attach the cover panel to the panel member; and a water guiding part that is provided in an area that is on an outer side of a side end of the attaching member on a surface of the cover panel on a side of the panel member, the water guiding part guiding water away from the attaching member toward a lower side in a vertical direction.

### CROSS REFERENCE TO RELATED APPLICATION

This application claims priority from Japanese Patent Application No. 2018-039490 filed on Mar. 6, 2018. The entire contents of the priority application are incorporated herein by reference.

### TECHNICAL FIELD

The technology described herein relates to a panel module.

### BACKGROUND

A panel module including a panel member (display cell) and a cover panel (front plate) that covers a front surface of the panel member has conventionally been known. The cover panel is attached to the panel member through an attaching member. An example of such a panel module is disclosed in Japanese Unexamined Patent Application Publication No. 2012-83597.

The cover panel as disclosed in Japanese Unexamined Patent Application Publication No. 2012-83597 may have, for example, the following problem: a water droplet is generated on a back surface of the cover panel (surface on the panel member side) due to condensation or the like and the water droplet goes along the attaching member toward the panel member. In this case, if the water droplet adheres to a conductive member such as a line of the panel member, the conductive member may corrode. The conductive member of the panel member is usually covered with a protective film, and the conductive member can be protected more certainly if the situation where water on the cover panel flows into the panel member can be suppressed. Thus, a countermeasure for such a situation has been demanded.

### SUMMARY

The technology described herein was made in view of the above circumstance. An object is to provide a panel module in which the situation where water adhering to a cover panel flows into a panel member can be suppressed.

A panel module according to the technology described herein includes: a panel member including a substrate with a plate surface that is extended along a direction intersecting with a horizontal direction, and a conductive member formed on the plate surface; a cover panel that covers the panel member from a side of the plate surface; an attaching member that is used to attach the cover panel to the panel member; and a water guiding part that is provided in an area that is on an outer side of a side end of the attaching member on a surface of the cover panel on a side of the panel member, the water guiding part guiding water away from the attaching member toward a lower side in a vertical direction. When water adheres to the surface of the cover panel on the side of the panel member due to condensation or the like, the water flows down along the surface of the cover panel. In this process, the water guiding part guides the water away from the attaching member. As a result, the situation where the water on the cover panel flows into the panel member through the attaching member can be suppressed, and the situation where the conductive member of the panel member corrodes due to the water can be suppressed.

According to the technology described herein, a panel module in which a situation where water adhering to a cover panel flows into a panel member can be suppressed can be provided.

### BRIEF DESCRIPTION OF THE DRAWINGS

FIG. 1 is a diagram illustrating a liquid crystal display device according to a first embodiment that is viewed from a back side.

FIG. 2 is a cross-sectional view of the liquid crystal display device (corresponding to a view that is taken along line II-II in FIG. 1).

FIG. 3 is a front view illustrating a CF substrate.

FIG. 4 is a cross-sectional view illustrating a cover panel (corresponding to a view that is taken along line IV-IV in FIG. 1).

FIG. 5 is a cross-sectional view illustrating a cover panel according to a second embodiment.

### DETAILED DESCRIPTION

### First Embodiment

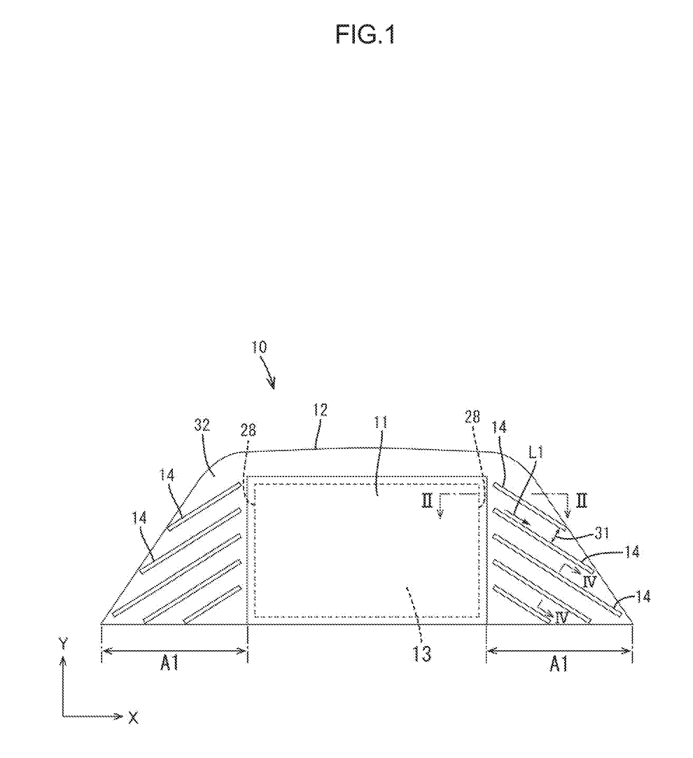

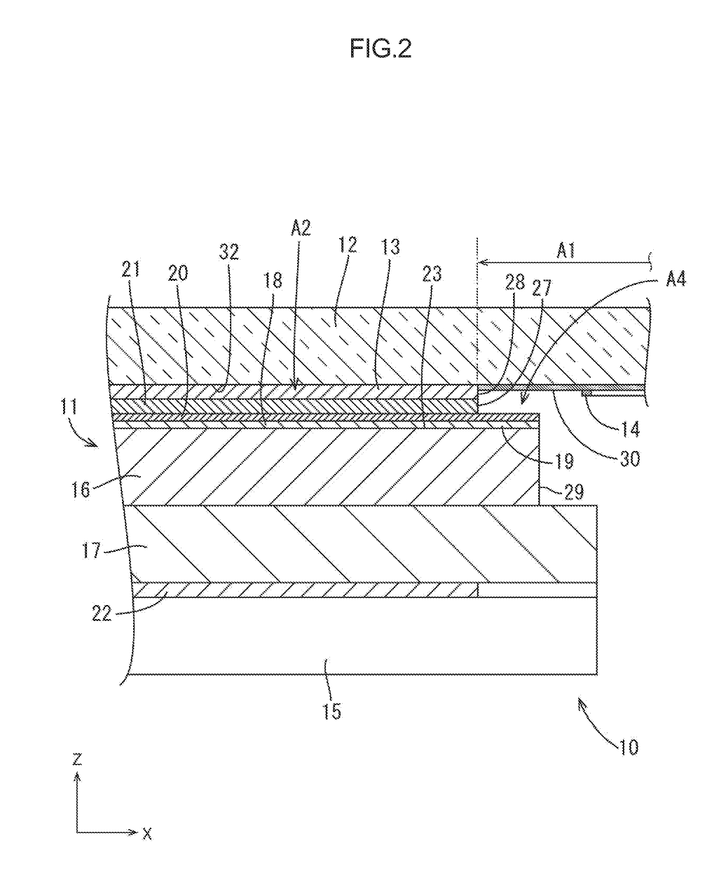

A first embodiment will be described with reference to FIGS. 1 to 4. The present embodiment describes a liquid crystal display device 10 as a panel module. As illustrated in FIG. 1 and FIG. 2, the liquid crystal display device 10 includes a liquid crystal panel 11 (panel member) with a rectangular plate shape, a cover panel 12 with an approximately trapezoidal shape that covers the liquid crystal panel 11, an attaching member 13 that is used to attach the cover panel 12 to the liquid crystal panel 11 (the attaching member 13 is shown with a dashed line in FIG. 1), water-repellent films 14 (water guiding part) provided to a surface 32 of the cover panel 12 on a side of the liquid crystal panel 11, and a backlight device 15 that delivers illumination light to the liquid crystal panel 11 for display (the backlight device 15 is not shown in FIG. 1). Note that FIG. 1 is a diagram illustrating the cover panel 12 and the liquid crystal panel that are viewed from the back side (side opposite to display surface). An upper side in FIG. 2 is the front side (display surface side) and a lower side in FIG. 2 is the back side. Note that, for example, the liquid crystal display device 10 according to the present embodiment can be used for a car navigation system or the like; however, the application is not limited to this example.

As illustrated in FIG. 2, the liquid crystal panel 11 includes: a pair of substrates 16 and 17, which is substantially transparent; and position detection electrodes 18 and position detection lines 19, a protective film 20, and polarizing plates 21 and 22, which are formed on the substrate 16. The pair of substrates 16 and 17 is attached together with a predetermined gap (cell gap) therebetween, and a liquid crystal layer, which is not shown, is interposed between the substrates 16 and 17. Of the pair of substrates 16 and 17, the substrate 17 is an array substrate 17 (TFT substrate) that is disposed on the back side. The array substrate 17 includes, on a glass substrate, structures such as a source line, a gate line, a switching element (for example, TFT), a pixel electrode, and an orientation film (none of them are shown). Of the pair of substrates 16 and 17, the substrate 16 is a CF substrate 16 (substrate) that is disposed on the front side. The CF substrate 16 includes structures such as a color filter where colored parts of R (red), G (green), B (blue), and the like are disposed in predetermined arrangement, a light-blocking part that sections between the adjacent colored parts, a counter electrode, and an orientation film (none of them are shown). The polarizing plate 21 is disposed on an outer surface side of the substrate 16, and the polarizing plate 22 is disposed on an outer surface side of the substrate 17. Note that a surface of the polarizing plate 21 that is attached to a side of the CF substrate 16 corresponds to the display surface of the liquid crystal panel 11.

The liquid crystal display device 10 according to the present embodiment is disposed in a standing posture as illustrated in FIG. 1. Therefore, each plate surface of the cover panel 12, the CF substrate 16, and the array substrate 17 in the liquid crystal display device 10 is extended along a vertical direction (one example of a direction that intersects with a horizontal direction). The cover panel 12 with the approximately trapezoidal shape is disposed in a posture in which a lower side is longer than an upper side. The liquid crystal panel 11 has a display function of displaying an image, and a touch panel function (position input function) of detecting a position (input position) where a user inputs on the basis of the displayed image. The position detection electrodes 18 and the position detection lines 19 (conductive members) for achieving the touch panel function are formed on a surface 23 of the CF substrate 16 (surface on display surface side, plate surface) as illustrated in FIG. 2. That is to say, the touch panel according to the present embodiment is an on-cell type.

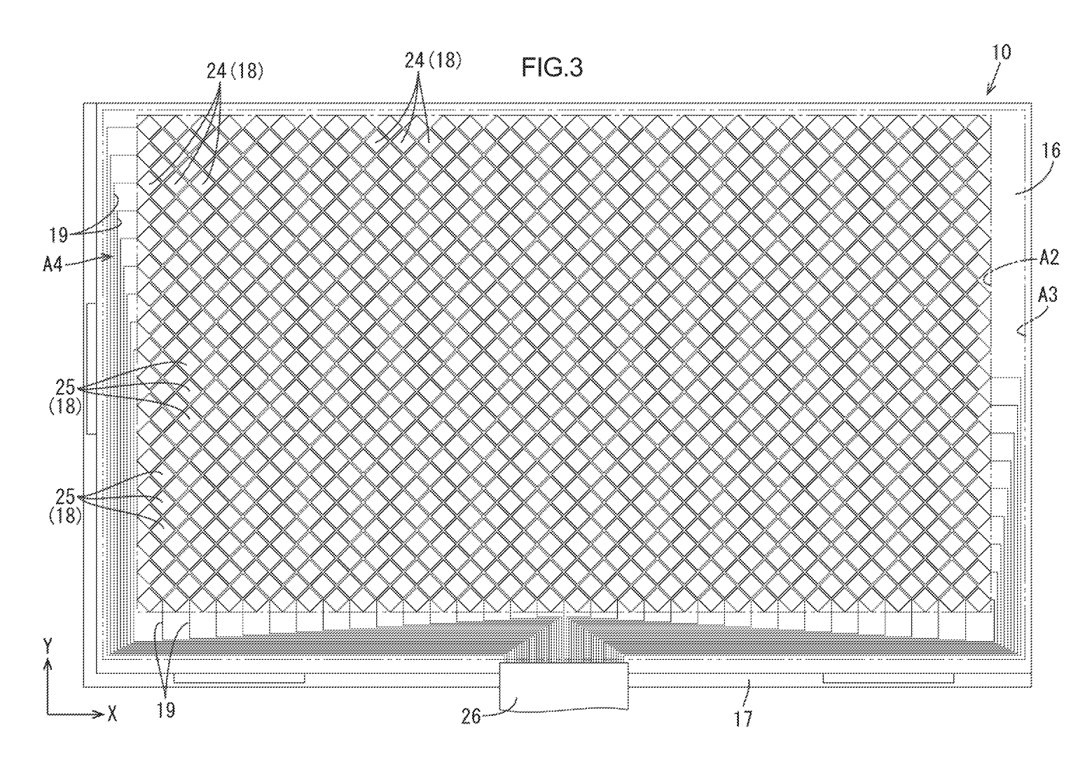

The position detection electrodes 18 are arranged in matrix on the CF substrate 16 as illustrated in FIG. 3. The position detection electrodes 18 are disposed in a display area A2 in the liquid crystal panel 11. Note that an area on an outer side of the display area A2 in the liquid crystal panel 11 is a non-display area A3 in the liquid crystal panel 11. As illustrated in FIG. 2, the display area A2 is an area on an inner side of the attaching member 13 and the non-display area A3 is an area on an outer side of the attaching member 13. When a user of the liquid crystal display device 10 puts his finger (not shown, position input body), which is a conductor, close to the display surface of the liquid crystal panel 11 through the cover panel 12, an electrostatic capacitance is generated between the finger and the position detection electrode 18. Thus, the electrostatic capacitance that is detected at the position detection electrode 18 near the finger changes as the finger gets closer, that is, this electrostatic capacitance becomes different from the electrostatic capacitance of the position detection electrode 18 that is far from the finger. As a result, based on the change, the input position by the finger can be detected.

The position detection electrode 18 has an approximately rhomboid shape in a plan view. The position detection electrodes 18 include first position detection electrodes 24 for detecting the input position in a Y-axis direction, and second position detection electrodes 25 for detecting the input position in an X-axis direction. The first position detection electrodes 24 are arranged linearly along the X-axis direction, and the first position detection electrodes 24 that are adjacent to each other in the X-axis direction are electrically connected to each other. The second position detection electrodes 25 are arranged linearly along the Y-axis direction, and the second position detection electrodes 25 that are adjacent to each other in the Y-axis direction are electrically connected to each other.

On the surface 23 of the CF substrate 16, the position detection lines 19 are formed. The position detection lines 19 connect the position detection electrodes 18 and a flexible substrate 26 for the touch panel. The position detection lines 19 are electrically connected to the first position detection electrodes 24 and the second position detection electrodes 25. The flexible substrate 26 is connected to the CF substrate 16 on one end side, and to a control substrate (not shown) of the liquid crystal display device 10 on the other end side. Thus, signals and the like used to detect the position, which are supplied from the control substrate, can be transmitted to the position detection electrodes 18 through the position detection lines 19. As illustrated in FIG. 3, the position detection lines 19 are formed along left and right side end parts and a lower end part in an outer periphery of the CF substrate 16. That is to say, a part of the position detection lines 19 is disposed in an area A4 that is on an outer side of a side end 28 of the attaching member 13 on the surface 23 of the CF substrate 16 as illustrated in FIG. 2.

The protective film 20 (overcoat film) is disposed to cover the position detection electrodes 18 and the position detection lines 19 as illustrated in FIG. 2. The protective film 20 may be formed of polyimide, acrylic resin, epoxy resin, or the like; however, the material is not limited to these examples. For example, the protective film 20 may be an inorganic protective film such as a nitride film or an oxide film. The polarizing plate 21 is disposed to cover the protective film 20. That is to say, the polarizing plate 21 is disposed between the CF substrate 16 and the cover panel 12. An end surface 27 of the polarizing plate 21 is disposed on an inner side of an end surface 29 of the CF substrate 16. The attaching member 13 is an adhesive layer such as an OCA (optical clear adhesive) film, and a material thereof is an ultraviolet-ray curable resin material that is cured when irradiated with an ultraviolet ray (photo curable resin material). The side end 28 of the attaching member 13 is disposed on the inner side of the end surface 29 of the CF substrate 16.

The cover panel 12 is formed of a material that is substantially transparent and has the excellent light-transmitting property (for example, glass). The cover panel 12 is disposed to cover the polarizing plate 21, and is attached to the polarizing plate 21 through the attaching member 13. That is to say, the cover panel 12 is configured to cover the CF substrate 16 from the surface 23 side (upper side in FIG. 2). As illustrated in FIG. 1, both side ends of the cover panel 12 are disposed on the outer side of both side ends of the liquid crystal panel 11.

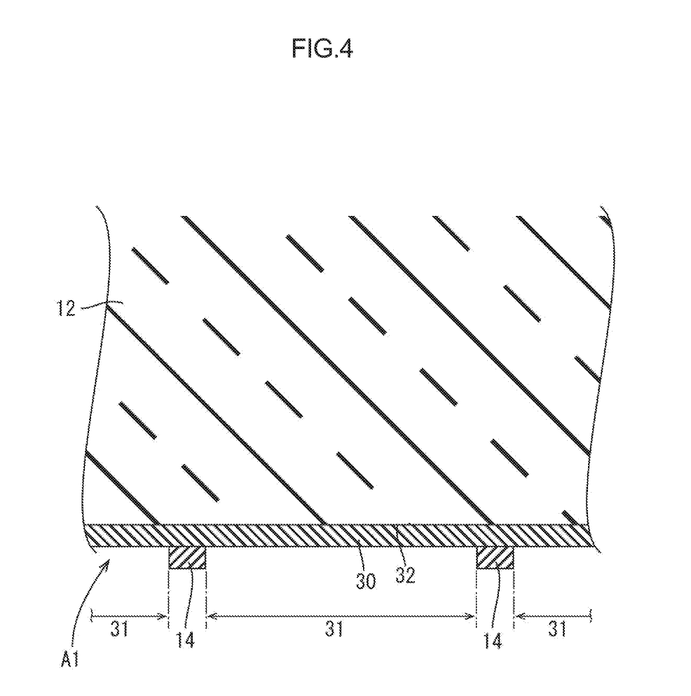

The cover panel 12 has a function of protecting the liquid crystal panel 11, and the height and the width of the cover panel 12 are set to be larger than those of the liquid crystal panel 11. Therefore, the surface 32 of the cover panel 12 on side of the liquid crystal panel 11 includes the area A1 that is positioned on the outer side of the side end 28 of the attaching member 13. The area A1 includes the water-repellent films 14 at positions. On the surface 32 of the cover panel 12 on the side of the liquid crystal panel 11, the area that is on the outer side of a peripheral end of the attaching member 13 includes a light-blocking layer 30 as illustrated in FIG. 2. This light-blocking layer 30 is formed by, for example, printing a coating that exhibits black color on the cover panel 12. The water-repellent film 14 is formed by applying a material with a high water-repellent property, such as fluorine or silicone, on a surface of the light-blocking layer 30 as illustrated in FIG. 4.

The water-repellent films 14 are formed to be extended away from the attaching member 13 toward a lower side in the vertical direction, and arranged along an up-down direction. Thus, in the area A1, water flows along a part 31 where the water-repellent film 14 is not formed (part between the adjacent water-repellent films 14). That is to say, the water-repellent film 14 guides the water away from the attaching member 13 toward the lower side in the vertical direction. The flow of water by the water-repellent film 14 is shown by an arrow L1 in FIG. 1. As illustrated in FIG. 1, the water-repellent films 14 are formed at left and right sides of a central part of the cover panel 12. That is to say, the cover panel 12 includes a pair of left and right areas A1 and A1, and the water-repellent films 14 in the right area A1 in FIG. 1 are extended to the right toward the lower side in the vertical direction, and the water-repellent films 14 in the left area A1 in FIG. 1 are extended to the left toward the lower side in the vertical direction.

Next, an effect of the present embodiment is described. In the present embodiment, if water (water droplet) adheres to the surface of the cover panel 12 on the side of the liquid crystal panel 11 due to condensation or the like, the water is guided away from the attaching member 13 by the water-repellent films 14 in the process of flowing down along the surface 32 of the cover panel 12. For example, in the right area A1 in FIG. 1, the water droplet is guided to the right in FIG. 1 by the water-repellent films 14 as the water droplet goes downward. As a result, a situation where the water on the cover panel 12 flows toward the liquid crystal panel 11 through the attaching member 13 can be suppressed, and a situation where the position detection lines 19 of the liquid crystal panel 11 corrode due to the water can be suppressed.

In addition, the water guiding part is formed by the water-repellent films 14 that are extended away from the attaching member 13 toward the lower side in the vertical direction. As the water flows along the water-repellent films 14, the water can be guided away from the attaching member 13 toward the lower side in the vertical direction.

The liquid crystal panel 11 includes the protective film 20 that covers the position detection lines 19. When the position detection lines 19 are covered with the protective film 20, a situation where the water adheres to the position detection lines 19 can be suppressed more certainly.

The liquid crystal panel 11 includes the polarizing plate 21 that is disposed between the CF substrate 16 and the cover panel 12. In a structure where the polarizing plate 21 is disposed between the CF substrate 16 and the cover panel 12, if water flows from the cover panel 12 to the liquid crystal panel 11, the water may reach the position detection lines 19 through the end surface 27 of the polarizing plate 21. In this case, a component of the polarizing plate 21 that exudes from the end surface 27 of the polarizing plate 21 (this component is, for example, iodine or acid) may be dissolved in water and such a component may corrode the position detection lines 19. In the above structure, the situation where the water on the cover panel 12 flows toward the liquid crystal panel 11 through the attaching member 13 can be suppressed; therefore, the situation where the position detection line 19 corrodes due to the water containing the component of the polarizing plate 21 can be suppressed.

The liquid crystal panel 11 includes the position detection electrodes 18 that detect the input position of the position input body, and the position detection lines 19 that are electrically connected to the position detection electrodes 18. The position detection lines 19 are disposed in the area that is on the outer side of the side end 28 of the attaching member 13 on the surface 23 of the CF substrate 16. Since the situation where the water on the cover panel 12 flows toward the liquid crystal panel 11 through the attaching member 13 can be suppressed, the situation where the water adheres to the position detection lines 19 can be suppressed.

As illustrated in FIG. 3, the position detection lines 19 are formed along the left and right side end parts and the lower end part in the outer periphery of the CF substrate 16. The water-repellent films 14 can guide the water droplet, which is generated in the area A1 of the cover panel 12, away from the attaching member 13; therefore, the situation where the water adheres to the position detection lines 19 that are disposed in the side end parts of the CF substrate 16 can be suppressed effectively.

In addition, in the present embodiment, the liquid crystal panel 11 has the rectangular shape and the cover panel 12 has the trapezoidal shape; therefore, the area A1 tends to be large. As the area A1 is larger, the water droplet is formed by condensation more easily. In this regard, the present embodiment is advantageous because the situation where the water droplet flows to the liquid crystal panel 11 can be suppressed by the water-repellent films 14.

### Second Embodiment

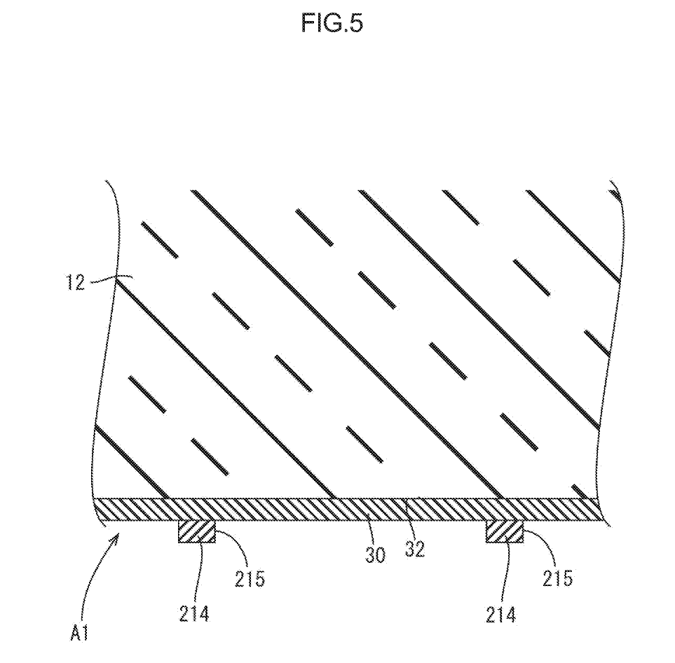

Next, a second embodiment will be described with reference to FIG. 5. The same part as that in the above embodiment is denoted by the same reference sign and the description of such a part is omitted. The present embodiment is different from the above embodiment in that projections 214 are provided as the water guiding part instead of the water-repellent films 14. The projections 214 are provided in the area A1 on the surface 32 of the cover panel 12 on the side of the liquid crystal panel. The projection 214 has a shape of projecting from a surface of the light-blocking layer 30 to the side of the liquid crystal panel (lower side in FIG. 5). The projection 214 also has a shape of being extended away from the attaching member 13 toward the lower side in the vertical direction, which is similar to the water-repellent film 14. Such a shape causes the water to flow along an upper surface 215 (a surface on the right side in FIG. 5) of the projection 214 in the area A1 of the cover panel 12; therefore, the water can be guided away from the attaching member 13 (not shown in FIG. 5) toward the lower side in the vertical direction. Note that the projection 214 as above can be formed by, for example, attaching a tape made of synthetic resin (for example, PET) to the back side of the cover panel 12 (in the present embodiment, the surface of the light-blocking layer 30). Note that the projection 214 is not limited to the tape and may be formed to be integrated with the cover panel 12.

### Other Embodiments

The technology described herein is not limited to the embodiments described above and with reference to the drawings. The following embodiments may be included in the technical scope.

(1) The liquid crystal panel is described as the panel member including the conductive member in the above embodiment; however, the panel member is not limited to the liquid crystal panel. The panel member without a display function may be used. Alternatively, the panel member may be, for example, a touch panel as a separate body from the liquid crystal panel (a touch panel of an out-cell type).

(2) The CF substrate 16 is described as the substrate in the above embodiment; however, the substrate is not limited to the CF substrate 16. The substrate may be the array substrate 17.

(3) The position detection line 19 is described as the conductive member in the above embodiment; however, the conductive member is not limited to the position detection line 19. The conductive member may be, for example, line for transmitting signals used to display in the liquid crystal panel. In addition, the conductive member is not limited to the line and may be in the form of an electrode, a terminal, or the like, for example.

(4) Each plate surface of the CF substrate 16, the array substrate 17, and the cover panel 12 is extended along the vertical direction in the above embodiment; however, the structure is not limited to this example. It is only necessary that each plate surface of the CF substrate 16, the array substrate 17, and the cover panel 12 is extended in the direction that intersects with the horizontal direction, and for example, the back surface of the cover panel 12 may be inclined to such a degree that the water droplet flows down on the back surface of the cover panel 12.

1. A panel module comprising:
a panel member including:
a substrate with a plate surface that is extended along a direction intersecting with a horizontal direction; and
a conductive member formed on the plate surface;
a cover panel that covers the panel member from a side of the plate surface;
an attaching member that is used to attach the cover panel to the panel member; and
a water guiding part that is provided in an area that is on an outer side of a side end of the attaching member on a surface of the cover panel on a side of the panel member, the water guiding part guiding water away from the attaching member toward a lower side in a vertical direction.

2. The panel module according to claim 1, wherein the water guiding part is a water-repellent film that is extended away from the attaching member toward the lower side in the vertical direction.

3. The panel module according to claim 1, wherein the water guiding part is a projection that is extended away from the attaching member toward the lower side in the vertical direction.

4. The panel module according to claim 1, wherein the panel member includes a protective film that covers the conductive member.

5. The panel module according to claim 1, wherein the panel member is a liquid crystal panel including a polarizing plate disposed between the substrate and the cover panel.

6. The panel module according to claim 1, wherein
the panel member includes a plurality of position detection electrodes detecting an input position of a position input body,
the conductive member is a position detection line that is electrically connected to the position detection electrode, and
the position detection line is disposed in an area on the plate surface that is on the outer side of the side end of the attaching member.
